(19) United States
(12) Patent Application Publication
(10) Pub. No.: US 2005/0000569 A1
(43) Pub. Date: Jan. 6, 2005

(54) Microfluidic devices and methods

(75) Inventors: Luc Bousse, Los Altos, CA (US); Mingqi Zhao, Cupertino, CA (US); John Stults, Redwood City, CA (US); Jing Ni, Sunnyvale, CA (US); Jonathan Heller, San Francisco, CA (US); Uthara Srinivasan, Palo Alto, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: BIOSPECT, INC. a Delaware Corporation, South San Francisco, CA (US); PREDICANT BIOSCIENCES, INC., South San Francisco, CA (US)

(21) Appl. No.: 10/794,572

(22) Filed: Mar. 4, 2004

Related U.S. Application Data
(63) Continuation-in-part of application No. 10/421,677, filed on Apr. 21, 2003.

(51) Int. Cl. F16L 58/04

(52) U.S. Cl. 137/375

(57) ABSTRACT

Microfluidic devices provide substances to a mass spectrometer. The microfluidic devices include first and second surfaces, at least one microchannel formed by the surfaces, and an outlet at an edge of the surfaces. Some embodiments also include a tip surface with one or more surface features for helping guide substances from the outlet of the device toward a mass spectrometer. In some embodiments, the surface feature(s) includes a groove, which may be hydrophilic along all or part of its length. Hydrophilic surfaces and/or hydrophobic surfaces may also help guide substances out of the outlet and/or toward the mass spectrometer. In some embodiments, the outlet and/or the tip surface is recessed back from an adjacent portion of the edge. A source of electrical potential can help move substances through the microchannel, separate substances and/or provide electrospray ionization.

### CROSS REFERENCE TO RELATED APPLICATIONS

The present invention is a Continuation-in-part of U.S. patent application Ser. No. 10/421,677, filed Apr. 21, 2003, and entitled “Microfluidic Devices and Methods,” which is hereby incorporated fully by reference.

### BACKGROUND OF THE INVENTION

The present invention relates generally to medical devices and methods, chemical and biological sample manipulation, spectrometry, drug discovery, and related research. More specifically, the invention relates to an interface between microfluidic devices and a mass spectrometer.

The use of microfluidic devices such as microfluidic chips is becoming increasingly common for such applications as analytical chemistry research, medical diagnostics and the like. Microfluidic devices are generally quite promising for applications such as proteomics and genomics, where sample sizes may be very small and analyzed substances very expensive. One way to analyze substances using microfluidic devices is to pass the substances from the devices to a mass spectrometer (MS). Such a technique benefits from an interface between the microfluidic device and the MS, particularly MS systems that employ electrospray ionization (ESI).

Electrospray ionization generates ions for mass spectrometric analysis. Some of the advantages of ESI include its ability to produce ions from a wide variety of samples such as proteins, peptides, small molecules, drugs and the like, and its ability to transfer a sample from the liquid phase to the gas phase, which may be used for coupling other chemical separation methods, such as capillary electrophoresis (CE), liquid chromatography (LC), or capillary electrochromatography (CEC) with mass spectrometry. Devices for interfacing microfluidic structures with ESI MS sources currently exist, but these existing interface devices have several disadvantages.

One drawback of currently available microfluidic MS interface structures is that they are not typically capable of providing one or more substances to an MS device at low flow rates. Low flow rates are desirable because less voltage is needed to form low-flow-rate substance(s) into a desired spray configuration for advancement to the MS device. When lower voltages are applied to substances, the ionization process is more efficient, and less ion suppression occurs, than when high voltages are applied. Low flow rates have been difficult to attain with currently available devices, however, because substances typically exit an outlet of a microfluidic device and spread across an edge and/or a tip of the device. Such spreading confounds accurate spraying of the substance(s) toward an MS device. Thus, to avoid substance spreading, currently available devices typically require application of higher voltages to the substances.

Another drawback of currently available microfluidic MS interface structures is that they typically make use of an ESI tip attached to the microfluidic substrate. These ESI tips are often sharp, protrude from an edge of the substrate used to make the microfluidic device, or both. Such ESI tips are both difficult to manufacture and easy to break or damage. Creating a sharp ESI tip often requires sawing each microfluidic device individually or alternative, equally labor intensive manufacturing processes. Another manufacturing technique, for example, involves inserting a fused-silica capillary tube into a microfluidic device to form a nozzle. This process can be labor intensive, with precise drilling of a hole in a microfluidic device and insertion of the capillary tube into the hole. The complexity of this process can make such microfluidic chips expensive, particularly when the microfluidic device is disposable. which leads to concern over cross-contamination of substances analyzed on the same chip.

Other currently available microfluidic devices are manufactured from elastomers such as polydimethylsiloxane (PDMS) and other materials that provide less fragile tips than those just described. These types of materials, however, are generally not chemically resistant to the organic solvents typically used for electrospray ionization.

Another drawback of current microfluidic devices involves dead volume at the junction of the capillary tube with the rest of the device. Many microfluidic devices intended for coupling to a mass spectrometer using an ESI tip have been fabricated from fused silica, quartz, or a type of glass such as soda-lime glass or borosilicate glass. The most practical and cost-effective method currently used to make channels in substrates is isotropic wet chemical etching, which is very limited in the range of shapes it can produce. Plasma etching of glass or quartz is possible, but is still too slow and expensive to be practical. Sharp shapes such as a tip cannot readily be produced with isotropic etching, and thus researchers have resorted to inserting fused-silica capillary tubes into glass or quartz chips, as mentioned above. In addition to being labor-intensive, this configuration can also introduce a certain dead volume at the junction, which will have a negative effect on separations carried out on the chip.

Some techniques for manufacturing microfluidic devices have attempted to use the flat edge of a chip as an ESI emitter. Unfortunately, substances would spread from the opening of the emitter to cover much or all of the edge of the chip, rather than spraying in a desired direction and manner toward an MS device. This spread along the edge causes problems such as difficulty initiating a spray, high dead volume, and a high flow rate required to sustain a spray.

Another problem sometimes encountered in currently available microfluidic ESI devices is how to apply a potential to substances in a device with a stable ionization current while minimizing dead volume and minimizing or preventing the production of bubbles in the channels or in the droplet at the channel outlet. A potential may be applied to substances, for example, to move them through the microchannel in a microfluidic device, to separate substances, to provide electrospray ionization, or typically a combination of all three of these functions. Some microfluidic devices use a conductive coating on the outer surface of the chip or capillary to achieve this purpose. The conductive coating, however, often erodes or is otherwise not reproducible. Furthermore, bubbles are often generated in currently available devices during water electrolysis and/or redox reactions of analytes. Such bubbles adversely affect the ability of an ESI device to provide substances to a mass spectrometer in the form of a spray having a desired shape. In particular, the presence of one or more bubbles in the microfluidic channel of a microfluidic device can interrupt both the flow and the electrical current needed to sustain electrospray ionization, thus disabling the device.

One proposed ESI tip design includes a groove to direct fluid. Such grooved ESI tips were described by Severine Le Gac et al. (Universite des Sciences et Technologies de Lille), in a poster presentation at the 51 st American Society for Mass Spectrometry Conference on Mass Spectrometry in Montreal, Canada, on Jun. 8-12, 2003. (Searchable at http://www.inmerge.com/aspfolder/ASMSSchedule2.asp.) Le Gac also described grooved ESI tips in the following references: “Two-dimensional microfabricated sources for nanoelectrospray”, Le Gac S, Arscott S, Cren-Olive C, Rolando C., J Mass Spectrom. 2003 December; 38(12): 1259-64; “A planar microfabricated nanoelectrospray emitter tip based on a capillary slot.”, Le Gac S, Arscott S, Rolando C., Electrophoresis. 2003 November; 24(21): 3640-7; and “A Novel Nib-Like Design for Microfabricated Nanospray Tips,” Severine Le Gac, Cécile Cren-Olivé, Christian Rolando, and Steve Arscott, J Am Soc Mass Spectrom 2004, 15, 409-412.

Le Gac's ESI tip design, however, has a number of shortcomings. For example, an important advantage of a microfluidic CE/MS interface is the ability to integrate the on-chip ESI device with other operations performed on the same chip, such as an electrophoretic or electrokinetic separation. These separations require closed channels, both to spatially confine the fluids on which an operation such as separation is performed, and to eliminate evaporation problems. In the field of ESI interfaces to mass spectrometry, the solutions used all have a significant organic component, making the evaporation problem more severe. In the ESI tips described by Le Gac et al., no enclosed channels are present, and these devices are used only for direct infusion to a mass spectrometer. No other operations on the chip are combined with the mass spectrometry interface, and Le Gac does not teach a method to incorporate closed channels. There is also no provision to control the flow rate of solution to the tip. Furthermore, the designs described by Le Gac et al., make use of a conductive material (silicon) as a support for their device, which makes it much more difficult to carry out electrokinetic operations which require the application of high voltage differences to different portions of the fluid in the microfluidic device.

Therefore, it would be desirable to have improved microfluidic devices that provide electrospray ionization of substances to mass spectrometers and that are easily manufactured. Ideally, such microfluidic devices would include means for electrospray ionization that provide desired spray patterns to an MS device at relatively low flow rates and that could be produced by simple techniques such as dicing multiple microfluidic devices from a common substrate. Also ideally, microfluidic devices would include means for providing a charge to substances without generating bubbles and while minimizing dead volume. At least some of these objectives will be met by the present invention.

### BRIEF SUMMARY OF THE INVENTION

Improved microfluidic devices and methods for making and using such devices provide one or more substances to a mass spectrometer for analysis. The microfluidic devices generally include first and second surfaces, at least one microchannel, and an outlet at an edge of the surfaces. Some embodiments include a tip surface, and some tips include one or more fluid guiding features to help guide substances out of the outlet to provide the substances to a mass spectrometer in a desired configuration, direction or the like. Fluid guiding features may include a groove in the tip, one or more hydrophilic and/or hydrophobic surfaces and/or the like. In some embodiments, the outlet and/or the tip surface is recessed from the adjacent edge of the surfaces. Such a tip may help guide the substances while remaining resistant to breakage due to its recessed position. To further enhance the delivery of substances, some embodiments include a source of electrical potential to move substances through a microchannel, separate substances and/or provide electrospray ionization.

In one aspect of the invention, a microfluidic device for providing one or more substances to a mass spectrometer for analysis of the substances includes: a microfluidic body having first and second major surfaces and at least one edge surface; at least one microchannel disposed between the first and second major surfaces, the microchannel having a microfabricated surface; at least one outlet in fluid communication with the microchannel and disposed along the edge surface; and at least one tip surface extending from the outlet and disposed in a path of fluid flow from the outlet, the tip surface having at least one fluid guiding feature to help guide fluid from the outlet toward the mass spectrometer.

In some embodiments, the microfabricated surface is disposed on one of the first and second major surfaces and the at least one tip surface comprises an extension of the other of the first and second major surfaces beyond the outlet. Optionally, the microchannel may be enclosed between the first surface and the second surface. Also optionally, two or more intersecting microchannels may be included in various embodiments. In some embodiments, the at least one tip surface comprises a protruding portion of a layer of film disposed between the first and second major surfaces.

The at least one fluid guiding feature may be any suitable feature or combination of features which help guide fluid from the outlet toward a mass spectrometer. In some embodiments, for example, the fluid guiding feature comprises a linear surface feature extending from a first location on the tip near the outlet to a second location at an edge of the tip. For example, the linear surface feature may include a groove extending at least partially through a thickness of the tip surface. In some embodiments, such a groove extends completely through the thickness of the tip surface, while in others it extends only partially through the thickness of the tip. In some embodiments, the groove comprises a laser-cut groove. The groove may generally have any suitable linear path. In one embodiment, for example, the tip surface comprises a pointed tip, and the groove extends from the outlet to the point of the tip. In another embodiment, the tip surface comprises an apex with a local radius of curvature of less than 40 micrometers, and the groove may extend from near the outlet to an edge of the semi-circle.

All or part of a linear surface feature may have a hydrophilic surface. For example, the hydrophilic surface may extend along the entire length of the linear surface feature. Such a hydrophilic surface may include, in some embodiments, a coated surface, a gel matrix, a polymer, a sol-gel monolith and/or a chemically modified surface. Examples of coatings on the coated surface may include, but are not limited to, cellulose polymers, polyacrylamide, polydimethylacrylamide, acrylamide-based copolymer, polyvinyl alcohol, polyvinylpyrrolidone, plyethylene oxide, Pluronic™ polymers, poly-N-hydroxyethylacrylamide, Tween™, dextran, a sugar, hydroxyethyl methacrylate and/or indoleacetic acid. A chemically modified surface may be modified, in some embodiments, by gas plasma treatment, plasma polymerization, corona discharge treatment, UV/ozone treatment, laser treatment, laser ablation and/or an oxidizing solution. In some embodiments, cutting one or more grooves in a microfluidic device with a laser may cause the cut surface to be more hydrophilic than an adjacent, uncut surface (such as an untreated polymer surface). Thus, in some embodiments a laser cutting or ablation process may serve two purposes simultaneously—i.e., cutting a groove and making the cut surface hydrophilic.

In alternative embodiments, the fluid guiding feature may include a hydrophilic surface along at least part of the tip surface, without a groove. In some embodiments, the hydrophilic surface may be combined with a hydrophobic surface along part of the tip, to further guide fluid in a desired path.

Electrospray ionization (ESI) tips may be used to direct one or more substances from a microfluidic device at relatively low flow rates. For example, in one embodiment a tip surface directs one or more substances toward the mass spectrometer at a flow rate of between about 10 and about 1000 nanoliters/minute, and more preferably between about 50 and about 500 nanoliters/minute, and in one embodiment about 100 nanoliters/minute. Optionally, the outlet and the tip surface of a microfluidic device may be recessed into the microfluidic body relative to an adjacent portion of the edge surface.

In some embodiments, at least part of the microfabricated surface comprises a hydrophilic surface. Hydrophilic surfaces can minimize or inhibit protein binding. As inhibiting of protein binding may be beneficial, in many embodiments at least a portion of the microfabricated surface may comprise a surface which minimizes or inhibits protein binding. The hydrophilic surface, for example, may comprise simply a part of the microfabricated surface adjacent the outlet. In other embodiments, the hydrophilic surface is disposed along the entire length of the microfabricated surface. Some examples of hydrophilic surfaces include a coated surface, a gel matrix, a polymer, a sol-gel monolith and a chemically modified surface. Coatings, for example, may include but are not limited to cellulose polymers, polyacrylamide, polydimethylacrylamide, acrylamide-based copolymer, polyvinyl alcohol, polyvinylpyrrolidone, polyethylene oxide, Pluronic™ polymers or poly-N-hydroxyethylacrylamide, Tween™ (polyoxyethylene derivative of sorbitan esters), dextran, a sugar, hydroxyethyl methacrylene, and indoleactic acid. A variety of methods are known to modify surfaces to make them hydrophilic (see e.g., Doherty et al, Electrophoresis, vol.24, pp. 34-54, 2003). For instance, an initial derivatization, often using a silane reagent, can be followed by a covalently bound coating of a polyacrylamide layer. This layer can be either polymerized in-situ, or preformed polymers may be bound to the surface. Examples of hydrophilic polymers that have been attached to a surface in this way include polyacrylamide, polyvinylpyrrolidone, and polyethylene oxide. Another method of attaching a polymer to the surface is thermal immobilization, which has been demonstrated with polyvinyl alcohol. In many cases, it is sufficient to physically adsorb a polymeric coating to the surface, which has been demonstrated with cellulose polymerss, polyacrylamide, polydimethylacrylamide, polyvinyl alcohol, polyvinylpyrrolidone, polyethylene oxide, Pluronic™ polymers (PEO-PPO-PEO triblock copolymers), and poly-N-hydroxyethylacrylamide. Certain techniques of surface modification are specific to polymer surfaces, for instance alkaline hydrolysis, or low-power laser ablation.

Optionally, the first major surface, the second major surface and/or the edge surface may include, at least in part, a hydrophobic surface. In some embodiments, for example, the hydrophobic surface is disposed adjacent the outlet. For example, the hydrophobic material may comprise an alkylsilane which reacts with a given surface, or coatings of cross-linked polymers such as silicone rubber (polydimethylsiloxane). The hydrophobic character of the polymer material may optionally be rendered hydrophilic by physical or chemical treatment, such as by gas plasma treatment (using oxygen or other gases), plasma polymerization, corona discharge treatment, UV/ozone treatment, laser treatment, laser ablation or oxidizing solutions.

Any suitable materials may be used, but in one embodiment the first and/or second major surfaces comprise a material such as glass, silicon, ceramic, polymer, copolymer, silicon dioxide, quartz, silica or a combination thereof. The polymer, for example, may include cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™ (polyester), Teflon™ (PTFE) or other acrylic-based polymers.

Optionally, an embodiment may include a source of pressure, such as hydrodynamic, centrifugal, osmotic, electroosmotic, electrokinetic, pneumatic or the like, coupled with the device to move the substances through the microchannel. Alternatively, the device may include an electrical potential source coupled with the device to move the substances through the microchannel. For example, the electrical potential source may comprise an electrical potential microchannel in fluid communication with the microchannel, the electrical potential microchannel containing at least one electrically charged substance. In other embodiments, the electrical potential source comprises an electrical potential microchannel which exits the microfluidic device immediately adjacent the microchannel, the electrical potential microchannel containing at least one electrically charged substance. In yet another embodiment, the electrical potential source comprises at least one electrode. In some embodiments, each electrode acts to separate the substances and to provide electrospray ionization. In others, each electrode acts to move the substances in the microchannel and to provide electrospray ionization. Such electrodes may comprise, for example, copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers. In some embodiments the at least one electrode generates the electrical potential without producing a significant quantity of bubbles in the substances.

In another aspect of the invention, a microfluidic device for providing one or more substances to a mass spectrometer for analysis of the substances includes: a substrate comprising at least one layer, the substrate including at least one microchannel, wherein the substances are movable within the microchannel; a cover arranged over the substrate; at least one outlet in fluid communication with the microchannel for allowing egress of the substances from the microchannel; and at least one tip surface extending the cover beyond the outlet, the tip surface having at least one fluid guiding feature to help guide fluid from the outlet toward the mass spectrometer. This aspect of the invention may include any of the features described above, in various embodiments.

In another aspect of the invention, a method of making a microfluidic device for providing one or more substances to a mass spectrometer for analysis of the substancesinvolves: fabricating a substrate comprising: forming at least one microchannel having a microfabricated surface; and forming an outlet in fluid communication with the microchannel and disposed along an edge surface of the substrate; fabricating a cover having at least one tip surface with at least one fluid guiding feature to help guide fluid from the outlet toward the mass spectrometer; and applying the cover to the substrate.

In some embodiments, fabricating the substrate involves forming at least two intersecting microchannels. Fabricating the cover, in some embodiments, involves forming the at least one tip surface in a cover precursor material and forming the at least one fluid guiding feature in the tip surface. In some embodiments, forming the fluid guiding feature involves forming at least one linear surface feature in the tip surface. Forming the linear surface feature, for example, may involve forming a groove extending at least partially through a thickness of the tip surface. In some embodiments, the groove extends completely through the thickness of the tip surface. In some embodiments, forming the tip surface comprises forming a pointed tip, and forming the groove comprises extending the groove from the outlet to a point of the pointed tip. Alternatively, forming the tip surface may involve forming a semi-circular tip having a radius of less than 40 micrometers, and forming the groove comprises extending the groove from the outlet to an edge of the semi-circular tip. In other embodiments, the tip may have any other suitable shape or configuration. The groove in the tip may be formed using any suitable technique, such as laser cutting, machining or the like. In some embodiments, for example, an excimer laser at a wavelength of 248 nm may be used.

A groove or other linear surface feature may be formed in some embodiments with a hydrophilic surface. The hydrophilic surface may extend along an entire length of the surface feature or along only part, and may include a coated surface, a gel matrix, a polymer, a sol-gel monolith, a chemically modified surface and/or the like, as described above in further detail. In some embodiments, forming the fluid guiding feature involves forming at least part of the tip surface with a hydrophilic surface, without forming a groove in the tip. Optionally, forming the fluid guiding feature may further include forming part of the tip surface with a hydrophobic surface.

Optionally, fabricating the substrate and applying the cover may involve recessing the outlet and the tip surface relative to an adjacent portion of the edge surface. Also optionally, forming the at least one microchannel may involve applying a hydrophilic coating to at least part of the microfabricated surface. For example, applying the coating may involve introducing the coating into the microchannel under sufficient pressure to advance the coating to the outlet. The coating may be any of the coatings mentioned above or any other suitable hydrophilic coating. Optionally, fabricating at least one of the substrate and the cover may include, at least in part, forming a hydrophobic surface. For example, the hydrophobic surface may be disposed adjacent the outlet.

In another aspect of the invention, a method for making a microfluidic device for providing one or more substances to a mass spectrometer for analysis of the substances comprises fabricating a microfluidic body comprising: first and second major surfaces with an edge surface therebetween; at least one microchannel disposed between the first and second major surfaces, the microchannel having a microfabricated surface; an outlet in fluid communication with the microchannel and disposed along the edge surface; and at least one tip surface extending one of the first and second major surfaces beyond the outlet, the tip surface having at least one fluid guiding feature to help guide fluid from the outlet toward the mass spectrometer.

In yet another aspect of the invention, a method of making microfluidic devices for providing one or more substances to a mass spectrometer for analysis of the substances comprises: forming at least one microchannel on a first substrate; providing a layer of film having at least one tip and at least one alignment feature, the tip having at least one fluid guiding feature to help guide fluid from the outlet toward the mass spectrometer; aligning the layer of film between the first substrate and a second substrate; and bonding the layer of film between the first and second substrates. In some embodiments, forming the at least one microchannel comprises embossing the microchannel onto the first substrate. Optionally, the method may further include forming a recessed edge in the first and second substrates. For example, forming the recessed edge may involve drilling a semi-circular recession into an edge of the first substrate and the second substrate.

In some embodiments, providing the layer of film comprises providing a polymer film, such as but not limited to a film of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ or other acrylic-based polymers. Also in some embodiments, the polymer is at least partially coated with at least one conductive material, such as but not limited to a material comprising copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

In other embodiments, the layer of film may be provided as a layer made entirely of metal. This metal may include any one or combination of suitable metals, such as but not limited to copper, nickel, conductive ink, silver, silver/silver chloride, gold, platinum, other noble metals, palladium, iridium, aluminum, titanium, tantalum, niobium or the like. Such a metal film may be cut or otherwise processed by any suitable method(s), such as but not limited to die cutting, laser ablation, electrodischarge machining, electrochemical etching or the like. The at least one fluid guiding feature may be disposed on the metal film layer using any suitable technique, such as those just listed or any of a number of others.

Providing the layer of film, in some embodiments, comprises forming the at least one tip and the at least one alignment feature using at least one of laser cutting, die-cutting or machining, though any other suitable technique may be used. Some embodiments further include forming at least one complementary alignment feature on at least one of the first and second substrates to provide alignment of the layer of film with the first and second substrates. Aligning may involve aligning the at least one alignment feature on the layer of film with at least one complementary alignment feature on at least one of the first and second substrates. Bonding may involve, for example, thermally bonding the first substrate to the second substrate with the layer of film disposed in between, though any other suitable technique may be used. Also, some embodiments may further involve separating the bonded first substrate, second substrate and layer of film to produce multiple microfluidic devices.

In some embodiments, providing the layer of film comprises forming at least one linear surface feature in the tip. For example, forming the linear surface feature may involve forming a groove in the tip extending through at least part of a thickness of the tip, as described fully above. The groove may be formed using any suitable technique, such as but not limited to laser cutting, die-cutting or machining. The method may optionally further include forming at least part of the groove from a hydrophilic material.

In another aspect of the invention, a method of making microfluidic devices for providing one or more substances to a mass spectrometer for analysis of the substances involves: forming at least one microchannel on a first substrate; forming a recessed edge on the first substrate and a second substrate; providing a layer of film having at least one tip and at least one alignment feature; aligning the layer of film between the first and second substrates; and bonding the layer of film between the first and second substrates.

In another aspect of the invention, a method for providing at least one substance from a microfluidic device into a mass spectrometer involves: moving the at least one substance through at least one microchannel in the microfluidic device; causing the substance to pass from the microchannel out of an outlet at an edge of the microfluidic device to contact at least one tip surface of the microfluidic device; and directing the at least one substance along a linear surface feature of the tip surface, the linear surface feature extending from immediately adjacent the outlet toward the mass spectrometer. The linear surface feature may comprise, for example, a groove extending at least partially through a thickness of the tip surface, as described more fully above.

In one embodiment, the at least one substance is moved through at least one microchannel by applying an electrical potential to the substance. Such an embodiment may further include using the electrical potential to separate one or more substances. In some embodiments, applying the electrical potential to the substance does not generate a significant amount of bubbles in the substance. In another embodiment, the substance is moved through at least one microchannel by pressure.

In some embodiments, causing the substance to pass from the microchannel out of the outlet comprises directing the substance with at least one of a hydrophobic surface and a hydrophilic surface of the microfluidic device. In some embodiments, causing the substance to pass from the microchannel out of the outlet may comprise directing the substance out of the outlet in a direction approximately parallel to a longitudinal axis of the at least one microchannel. Alternatively, causing the substance to pass from the microchannel out of the outlet may comprise directing the substance out of the outlet in a direction non-parallel to a longitudinal axis of the at least one microchannel. In some cases, causing the substance to pass from the microchannel out of the outlet comprises directing the substance out of the outlet in the form of a spray having any desired shape or configuration.

These and other aspects and embodiments of the present invention are described in further detail below.

### BRIEF DESCRIPTION OF THE DRAWINGS

FIG. 1 is a perspective view of a portion of a microfluidic device having a recessed outlet according to an embodiment of the present invention.

FIG. 1A is a top view of a substrate of a microfluidic device having a recessed ESI tip, such as the device shown in FIG. 1, according to an embodiment of the present invention.

FIG. 1B is a side view of a microfluidic device having a recessed outlet according to an embodiment of the present invention.

FIG. 1C is a perspective view of a portion of a microfluidic device having a tip with a linear surface feature according to an embodiment of the present invention.

FIG. 1D is a top view of a portion of a microfluidic device having a tip with a linear surface feature according to an embodiment of the present invention.

FIG. 2A is a side, cross-sectional view of a microfluidic device having a cover with an outlet and an adjacent surface feature according to an embodiment of the present invention.

FIG. 2B is a side, cross-sectional view of a microfluidic device having a cover with an outlet passing through a surface feature of the cover according to an embodiment of the present invention.

FIG. 2C is a side, cross-sectional view of a microfluidic device having a cover with an outlet and a substrate having a surface feature adjacent the microchannel according to an embodiment of the present invention.

FIGS. 3A-3C are top views depicting a method for making a microfluidic device having a recessed outlet and an electrode according to an embodiment of the present invention.

FIGS. 4A-4C are top views depicting a method for making a microfluidic device having an electrode according to an embodiment of the present invention.

FIGS. 5A-5C are top views depicting a method for making a microfluidic device having an electrode according to an embodiment of the present invention.

FIG. 6 is a perspective view of a portion of a microfluidic device manufactured according to principles of the present invention.

### DETAILED DESCRIPTION OF THE INVENTION

Improved microfluidic devices and methods for making and using such devices provide one or more substances to a mass spectrometer for analysis. The microfluidic devices generally include a substrate having first and second surfaces (or a substrate and a cover, or the like) at least one microchannel formed by the surfaces, and an outlet at an edge of the surfaces. Some embodiments further include a tip surface, and in some embodiments the outlet and/or the tip is recessed back from an adjacent portion of the edge of the surfaces. Such a tip may help guide the substances while remaining resistant to breakage due to its recessed position. Some embodiments include one or more fluid guiding features on the tip surface, near the outlet, or elsewhere to help guide substances from the outlet toward a mass spectrometer in a desired configuration, direction or the like. Such fluid guiding features may include, for example, a linear surface feature such as a groove in a tip surface and/or one or more hydrophilic surfaces and/or hydrophobic surfaces on a tip surface, a surface of a microchannel, and/or the like. Hydrophilic surfaces may minimize or inhibit protein binding, which may also be beneficial, so that alternative surfaces which inhibit protein binding may also be employed in place of the hydrophilic surfaces described herein. To further enhance the delivery of substances, some embodiments include a source of electrical potential to move substances through a microchannel, separate substances and/or provide electrospray ionization.

The invention is not limited to the particular embodiments of the devices described or process steps of the methods described, as such devices and methods may vary. Thus, the following description is provided for exemplary purposes only and is not intended to limit the invention as set forth in the appended claims.

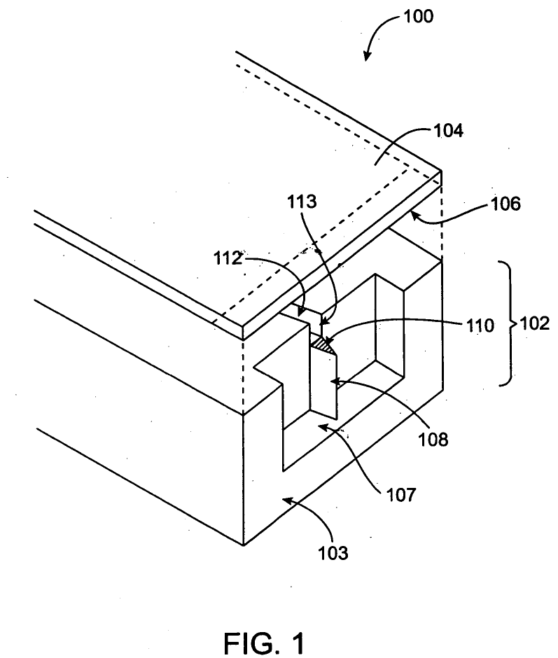

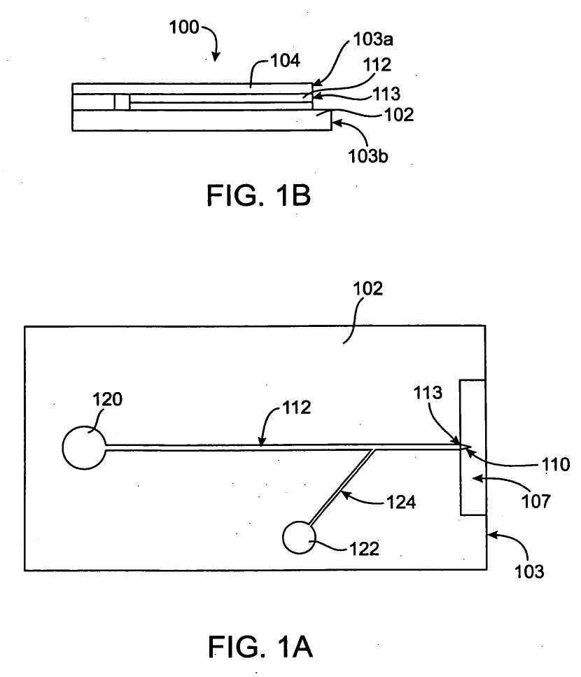

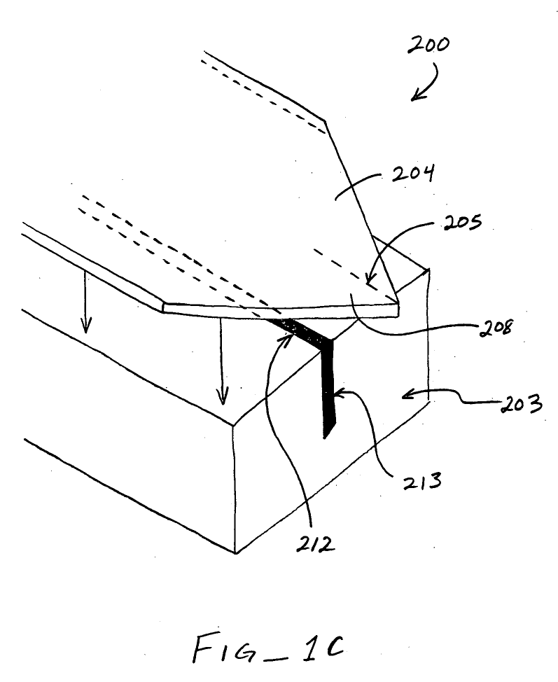

Referring now to FIG. 1, a portion of a microfluidic device 100 comprising a substrate 102 and a cover 104 is shown. (FIG. 1A shows an example of a complete substrate 102 of such a device, according to one embodiment.) The term “substrate” as used herein refers to any material that can be microfabricated (e.g., dry etched, wet etched, laser etched, molded or embossed) to have desired miniaturized surface features, which may be referred to as “microstructures.” Microfabricated surfaces can define these microstructures and other, optionally larger structures. Microfabricated surfaces and surface portions can benefit from a dimensional tolerance of 100 μms or less, often being 10 μms or less, the tolerances of the microfabricated surfaces and surface portions more generally being significantly tighter than provided by dicing (substrate cutting or separating) techniques that may define adjacent portions and surfaces. Examples of microstructures include microchannels and reservoirs, which are described in further detail below. Microstructures can be formed on the surface of a substrate by adding material, subtracting material, a combination of both, pressing, or the like. For example, polymer channels can be formed on the surface of a glass substrate using photo-imageable polyimide. Substrate 102 may comprise any suitable material or combination of materials, such as but not limited to a polymer, a ceramic, a glass, a metal, a composite thereof, a laminate thereof, or the like. Examples of polymers include, but are not limited to, polyimide, polycarbonate, polyester, polyamide, polyether, polyolefin, polymethyl methacrylates, polyurethanes, polyacrylonitrile-butadiene-styrene copolymers, polystyrene, polyfluorcarbons, and combinations thereof. Furthermore, substrate 102 may suitable comprise one layer or multiple layers, as desired. When multiple substrate layers are provided, the layers will often be bonded together. Suitable bonding methods may include application of a combination of pressure and heat, thermal lamination, pressure sensitive adhesive, ultrasonic welding, laser welding, and the like. Generally, substrate 102 comprise any suitable material(s) and may be microfabricated by any suitable technique(s) to form any desired microstructure(s), shape, configuration and the like.

Cover 104 generally comprises any suitable material, such as the materials described above in reference to substrate 102. Thus, cover 104 may comprise a polymer, a ceramic, a glass, a metal, a composite thereof, a laminate thereof, or any other suitable material or combination. As is described further below, in various embodiments cover 104 may comprise a simple, planar component without notable surface features, or may alternatively have one or more surface features, outlets or the like. In FIG. 1, cover 104 is raised up off of substrate 102 to enhance visualization of device 100.

In some embodiments, substrate 102 includes one or more microchannels 112, at least one of which is in fluid communication with an outlet 113. Microchannel 112 (as with all microfluidic channels described herein) will often have at least one cross-sectional dimension (such as width, height, effective diameter or diameter) of less than 500 μm, typically in a range from 0.1 μm to 500 μm. Substrate 102 may include a plurality of such channels, the channels optionally defining one, two, or more than two intersections. Typically, substances are moved through microchannel 112 by electric charge, where they also may be separated, and the substances then exit device 100 via outlet 113 in the form of an electrospray directed towards a mass spectrometer or other device. In some embodiments, outlet 113 may be located in a recessed area 107, which is recessed from an edge 103 of device 100. Recessed area 107 generally serves the purpose of protecting an ESI tip 108, which extends beyond outlet 113, from being damaged or broken during manufacture or use. ESI tip 108, in some embodiments, may include a hydrophilic surface 110, such as a metalized surface, which may help form a desirable configuration of an electrospray, such as a Taylor cone.

In some embodiments, microfluidic device 100 includes at least one hydrophilic surface 110 and at least one hydrophobic surface (shaded area and 106). Either type of surface may be used in portions of substrate 102, cover 104 or both. Generally, such hydrophilic and hydrophobic surfaces allow substances to be sprayed from device 100 in a desired manner. In FIG. 1, for example, a portion of cover 104 comprises a hydrophobic surface 106 facing toward substrate 102 and microchannel 112. All the surface of recessed area 107 is also hydrophobic. These hydrophobic surfaces prevent fluidic substances exiting outlet 113 from spreading along an edge or surface of device 100 rather than spraying toward a mass spectrometer as desired. At the same time, hydrophilic surface 110 and a microchannel having a hydrophilic surface may help keep fluidic substances generally moving along a desired path defined by the microchannel and hydrophilic surface 110. This combination of hydrophilic and hydrophobic surfaces is used to enhance ESI of substances to a device such as a mass spectrometer.

Referring now to FIG. 1A, a top view of one embodiment of substrate 102 is shown. Microstructures on substrate 102 may include any combination and configuration of structures. In one embodiment, for example, a reservoir 120 for depositing substances is in fluid communication with microchannel 112 which leads to outlet. Some embodiments further include a second reservoir 122 wherein an electrically charged material may be deposited. This electrically charged material may be used to apply a charge to substances in microchannel 112 via a side-channel 124. Typically, side-channel 124 will have a smaller cross-sectional dimension than microchannel 112, so that substances will not tend to flow up side-channel. Electric charge is applied to substances in microfluidic device 100 for both the purposes of separating substances and providing ESI.

Referring to FIG. 1B, a side view of another embodiment of microfluidic device 100 is shown. This embodiment demonstrates that outlet 113 may be disposed along an edge 103a of device 100 while at the same time being recessed from an adjacent edge portion 103b. Edge 103a where outlet 113 is located may be more finely manufactured compared to adjacent edge portion 103b, which may be roughly cut or otherwise manufactured via a less labor intensive process.

With reference now to FIG. 1C, another embodiment of a microfluidic device 200 includes a substrate 203 and a cover 204 (raised off of substrate 203 to better demonstrate device 200). Substrate 203 includes at least one microchannel 212 having an outlet 213. Cover 204 is configured to include a tip 208, having a groove 205. Groove 205, in this embodiment, is shown as a dotted line to designate that groove 205 is located on the side of cover 204 that faces substrate 203 and that groove 205 extends only partially through the thickness of cover 204. In other embodiments, groove 205 may extend fully through the thickness of cover 204. Partial-thickness grooves 205 may be advantageous in that the two halves of tip 208 separated by groove 205 are unlikely to move out of alignment with use of the device. Full-thickness grooves may be advantageous in some instances, however, as they may enhance guidance of fluid toward a mass spectrometer more than partial-thickness grooves 205. Generally, cover 204 is aligned with and disposed on substrate 203 such that groove 205 extends from a location immediately adjacent or near outlet 213 to an edge or point of tip 208. Groove 204 helps direct fluid from outlet 213 toward the end of tip 208 and thus toward a mass spectrometer or similar device.

As mentioned above, ESI tips with grooves have been previously described, most specifically in several poster presentations and articles by Severine Le Gac et al. (referenced above). In Le Gac's ESI tips, however, the groove at the tip also extends in the same material and is used as an open conduit to transport fluid to the tip. Microfluidic devices have not been described that have grooved tips on one surface and one or more closed microchannels on another surface. The channel(s) on Le Gac's device are open, whereas grooved tips of the present invention are typically combined with enclosed microchannels—i.e., enclosed between the substrate and the cover. Other novel features of grooved tips of the present invention are described more fully below and in the appended claims.

As described above, any suitable material may be used to fabricate cover 204, such as a polymer, a ceramic, a glass, a metal, a composite thereof, a laminate thereof, or any other suitable material or combination. In some embodiments, cover is laser cut to form tip 208 and/or groove 205. In some embodiments, for example, a relatively fast laser, such as a frequency-tripled YAG laser, may be used to make some or all cuts required to form tip 208 and groove 205. In other embodiments, an excimer laser at a frequency around 248 nm or the like may be used to make some or all cuts in cover 204. Sometimes a combination of lasers may be used, and any other type or frequency of laser may additionally or alternatively be used.

In various embodiments, groove 205 may have a hydrophilic surface along all or part of its length. Materials and methods for forming a hydrophilic surface are described more fully above and below, but generally any suitable material(s) and method(s) may be used. In some embodiments, for example, a hydrophilic coating may be applied to groove 205. Optionally, all or part of tip 208 surrounding groove may be fabricated from and/or coated with a hydrophobic material. Such a hydrophobic tip 208, when combined with a hydrophilic groove 205, may enhance guidance of substances along groove 205 and toward a mass spectrometer. Thus, any combination of linear surface features, such as grooves, and hydrophilic or hydrophobic materials or coatings may be used in a given embodiment of a microfluidic device.

Referring now to FIG. 1D, a top view of a portion of a microfluidic device 220 is shown, the device 220 including a substrate 223 and a cover 224. Again, substrate 224 includes one or more microchannels 232, at least one of which is in fluid communication with an outlet 233, and an edge surface 226. Cover 224 includes a tip 228 and a groove 225. Here, groove 225 extends through the full thickness of cover 224, as designated by the continuous line. FIG. 1D demonstrates that tip 228 and outlet 233 need not be recessed from edge surface 226 in all embodiments. The figure also shows that groove 225 will typically be configured, and cover 224 will be aligned on substrate 223, such that groove 225 extends from an area immediately adjacent or near outlet 233 to an edge or point of tip 228.

ESI tips with grooves or similar surface features for guiding fluid may allow substances to be provided to a mass spectrometer using relatively low flow rates. Using low flow rates is advantageous in ESI devices because it leads to more efficient ionization, higher sensitivity and reduced ion supression. Using grooved ESI tips, for example, may allow a microfluidic device to provide substance(s) to a mass spectrometer at a flow rate of between about 10 and about 1000 nanoliters/minute, and more preferably between about 50 and about 500 nanoliters/minute, and in one embodiment about 100 nanoliters/minute. ESI tips with grooves or other similar linear surface features make use of such low flow rates possible by helping direct fluids from the outlet of the microfluidic device toward the mass spectrometer.

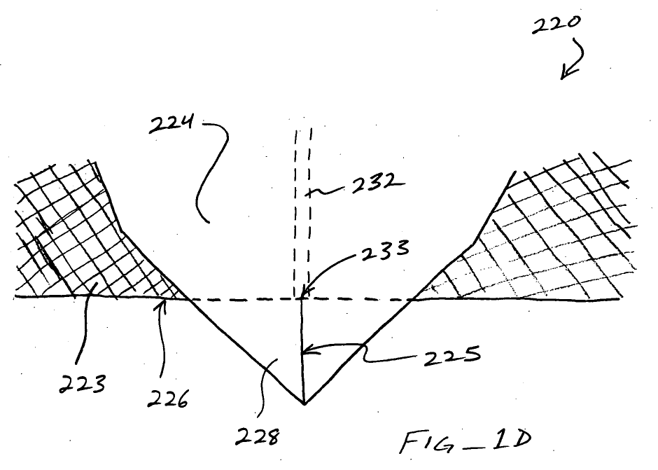

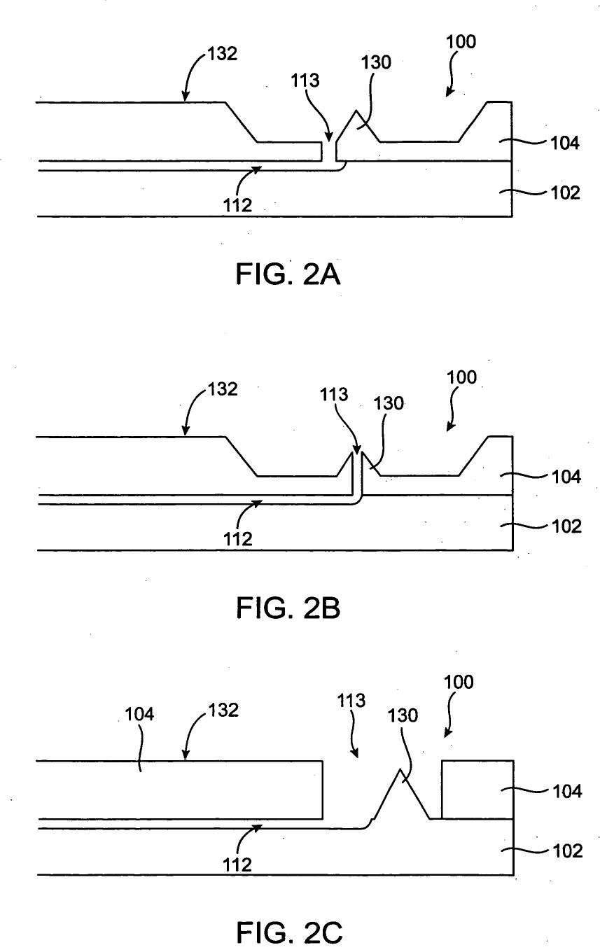

Referring now to FIG. 2A, in some embodiments substrate 102 and cover 104 of device 100 comprise generally planar surfaces, with cover 104 disposed on top of substrate 102. Cover 104 may include one or more surface features 130 and an outlet 113 which, like outlet shown in previous figures, is in fluid communication with microchannel 112. In some embodiments, surface feature 130 is recessed, such that it does not extend beyond a top-most surface 132 of device 100. This protects surface feature 130 from damage. Generally, substrate 102 and cover 104 may be made from any suitable materials and by any suitable manufacturing methods. In one embodiment, for example, substrate 102 is embossed or molded with a pattern of microchannels 112 having typical microfluidic dimensions, while cover 104 is embossed or machined with a tool made from a silicon master. This process allows device 100 to be manufactured via standard anisotropic etching techniques typically used for etching a silicon wafer.

Outlet 113 is typically placed in cover 104 adjacent to or nearby surface feature 130 and may be made in cover 104 using any suitable method. Ideally, the effective diameter, diameter, width, and/or height of outlet 113 is as small as possible to reduce dead volume which would degrade the quality of any separation of substances which had been accomplished upstream of outlet 113. The term “dead volume” refers to undesirable voids, hollows or gaps created by the incomplete engagement, sealing or butting of an outlet with a microchannel. In some embodiments, for example, outlet 113 has a cross-sectional dimension (as above, often being width, height, effective diameter, or diameter) of between about 20 μms and about 200 μms and preferably between about 50 μms and about 150 μms. Outlet 113 may be formed, for example, by microdrilling using an excimer laser in an ultraviolet wavelength, though any other suitable method may be substituted. In another embodiment, outlet 113 may be made by positioning a pin in the desired location for outlet 113 in a mold and then making device 100 via injection molding.

In some embodiments of a microfluidic device 100 as shown in FIG. 2A, hydrophobic and/or hydrophilic surfaces are used to enhance ESI of substances out of device 100. In one embodiment, for example, the surface of cover 104 that forms outlet 113 as well as at least a portion of the surface of surface feature 130 are both relatively hydrophilic, and/or both inhibit protein binding. This hydrophilicity helps guide substances out of outlet 113 and along surface feature 130 toward a mass spectrometer or other device. In one embodiment, the hydrophilic surfaces are formed by an oxygen plasma, masked by a resist layer so that its effect is localized. In another embodiment, a thin film of hydrophilic polymer or surface coating may be deposited, for example by using a device such as a capillary tube filled with the solution of interest. The hydrophilic polymer or surface coating may be disposed through microchannel 112 under sufficient pressure to push the coating just to the outside end of outlet 113, for example, so that the length of microchannel 112 and outlet 113 are coated. Such methods may be used to coat any microchannel 112 and/or outlet 113 with hydrophilic substance(s). In addition to the hydrophilic surface(s) of microchannel 112, outlet 113 and/or surface feature 130, other surfaces of device 100 may be hydrophobic to prevent spreading of substances along a surface. For example, a surface adjacent outlet 113 may be made hydrophobic to prevent such spreading.

Referring now to FIG. 2B, in another embodiment outlet 113 passed through surface feature 130. Again, surface feature 130 may be recessed so as to not extend beyond top-most surface 132. Outlet 113 can be formed through surface feature 130 by any suitable means, such as laser ablation drilling.

In still another embodiment, as shown in FIG. 2C, cover may not include a surface feature, and instead a surface feature 130 may be formed on substrate 102. This surface feature 130 may be formed by any suitable means, just as when the surface feature is positioned on cover 104. In any of the embodiments, surface feature 130 may have any suitable shape and size, but in some embodiments surface feature 130 is generally pyramidal in shape. Advantageously, forming surface feature 130 on substrate 102 and manufacturing surface feature 130 and microchannel 112 to have hydrophilic surfaces may allow a very simple, planar cover 104 having a relative large outlet 113 to be used. The large outlet 113 is advantageous because it is often difficult to line up (or “register”) a small outlet 113 on cover 104 at a desired location above microchannel 112. Improper registration or alignment of cover 104 on substrate 102 may reduce the accuracy of an electrospray and the performance of microfluidic device 100. By manufacturing a device 100 having a cover 104 with a large outlet 113, precise placement of cover 104 on substrate 104 during manufacture becomes less important because there is simply more room for error—i.e., more room for fluid to leave microchannel 112. By using sufficiently hydrophilic surfaces on microchannel 112 and surface feature 130, electrospray ionization of substances may be provided despite the relatively large diameter of outlet 113 as shown in FIG. 2C.

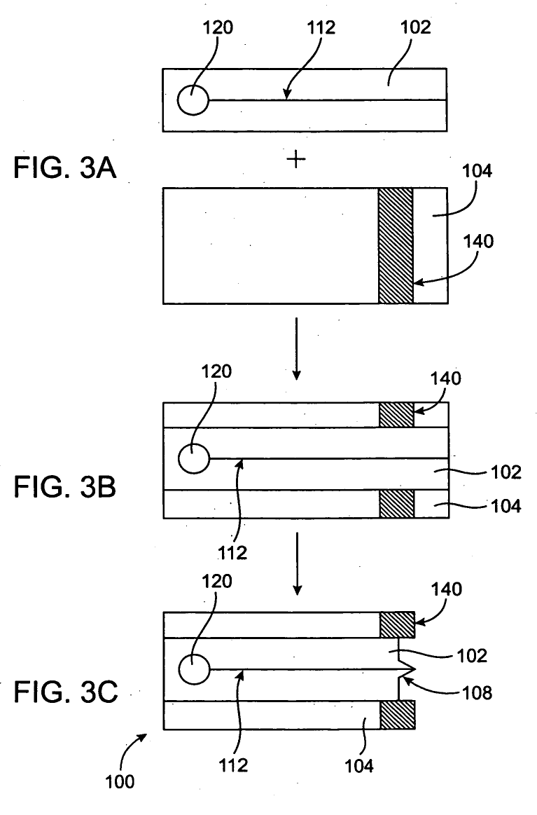

Referring now to FIGS. 3A-3C, a method for making a microfluidic device 100 is shown. In one embodiment, polymer films (for example between 50 μms and 200 μms) or polymer sheets (for example between 200 μms and 2 mm) may be used to form substrate 102 and cover 104 (FIG. 3A). An electrode 140 may be disposed on cover 104 and/or on substrate 102. In some embodiments, electrode 140 comprises a high-voltage electrode capable of acting as both an anode and a cathode for various purposes. For example, in a positive-ion mode, electrode 140 in some embodiments acts as a cathode for capillary electrophoresis separation of substances and as an anode for electrospray ionization. This means that both reduction and oxidation reaction occur in the same electrode, but typically the reduction reaction dominates. Electrode 140 may be formed by depositing one or more metals, printing conductive ink, or otherwise coupling a conductive material with cover 102. In one embodiment, silver or silver chloride may be used, though many other possible materials are contemplated. Generally, using such an electrode 140 to provide electric charge to substances in device 100 avoids generation of bubbles in the substances, as often occurs in currently available devices. Such electrodes also help minimize dead volume and are relatively easy to manufacture and effective to use.

In FIG. 3B, substrate 102 and cover 104 have been coupled together. Often, this is accomplished via a lamination process of cover 104 over substrate 102, but any other suitable method(s) may be used. Finally, in FIG. 3C, microfluidic device 100 is laser cut or otherwise precisely cut to form recessed tip 108. Of course, recessing the tip is optional, as has been mentioned. Any suitable method may be used for such precise cutting of tip 108 and the rest of the edge of device 100. In other embodiments, device 100 may be manufactured so as to not include tip 108 at all, but rather to have an outlet that exits from a flat edge. Again, combinations of hydrophilic (and/or protein binding inhibiting) and hydrophobic surfaces may be used to prevent spread of fluid from the outlet along the edge of device 100. Additionally, electrode 140 may be positioned at any other suitable location on device 100. In one embodiment, for example, all or part of electrode 140 may be disposed on tip 108. Thus, any suitable method for making device is contemplated.

In using any of the microfluidic devices described above or any other similar devices of the invention, one or more substances are first deposited in one or more reservoirs on a microfluidic device. Substances are then migrated along microchannel(s) of the device and are typically separated, using electric charge provided to the substances via an electrode or other source of electric charge. An electrode may also be used to help move the substances along the microchannels in some embodiments. Charge is also provided to the substances in order to provide electrospray ionization of the substances from an outlet of the device toward a mass spectrometer or other device. In many embodiments, the electrospray is provided in a desired spray pattern, such as a Taylor cone. In some embodiments, the spray is directed generally parallel to the longitudinal axis of the microchannel from which it comes. In other embodiments, the spray is directed in a non-parallel direction relative to the microchannel axis. The direction in which the spray is emitted may be determined, for example, by the shape of an ESI tip, by hydrophobic and/or hydrophilic surfaces adjacent the outlet (and/or protein binding characteristics), by the orientation of the outlet, and/or the like. In some cases it may be advantageous to have either a parallel or non-parallel spray.

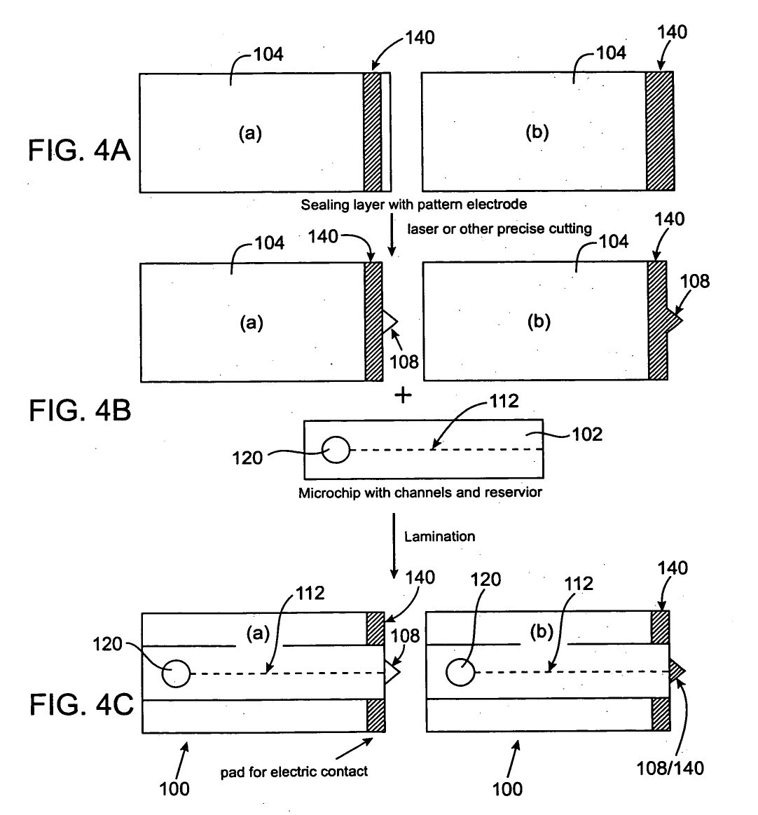

FIGS. 4A-4C show two alternative embodiments of a method for making microfluidic device 100. These methods are similar to the one shown in FIGS. 3A-3C, but cutting or other fabricating of tip 108, as shown in FIG. 4B, is performed before coupling cover 104 with cubstrate 104. In these embodiments, electrode 140 is disposed close to tip 108, as shown on the left-sided figures (a), and/or on tip 108, as shown in the right-sided figures (b).

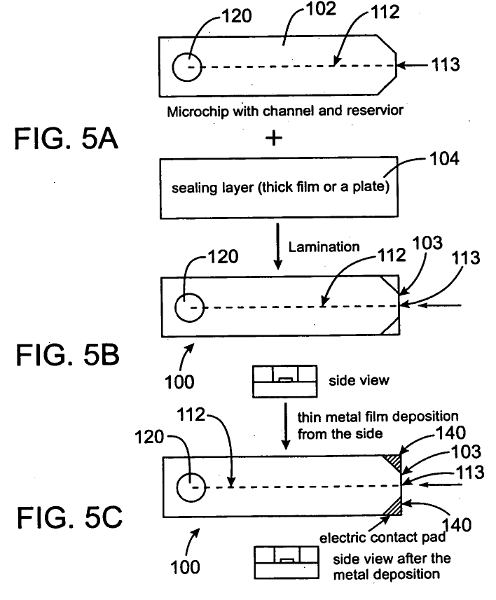

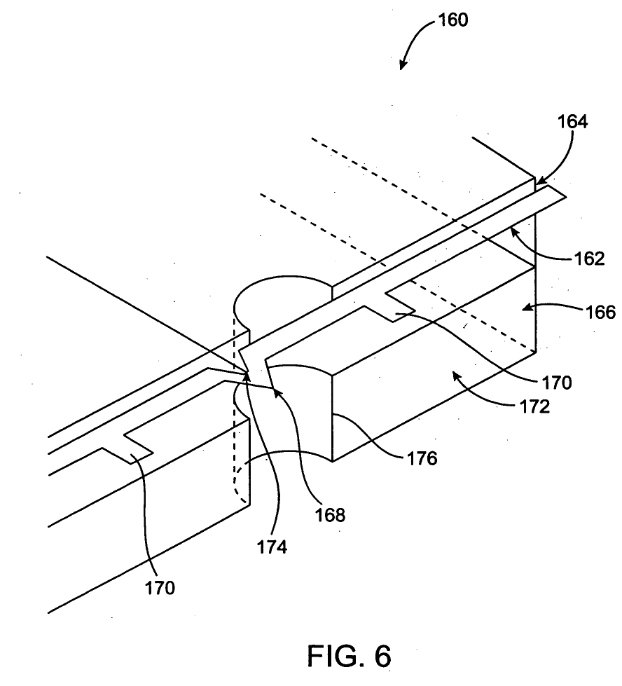

Referring now to FIGS. 5A-5C, another embodiment of a method of making microfluidic device 100. This embodiment does not include a tip, but positions outlet 113 at edge 103. In some embodiments, edge 103 may be recessed from an adjacent edge portion. A metal film, conductive ink or other electrode 140 is positioned near outlet 113. The method includes depositing a thin film of metal, conductive ink or the like onto the side of device 100 after lamination, as shown in the figures. In some embodiments, another cutting, followed by polishing could be performed before the deposition of the film, for example if the alignment between the top and bottom edges to be deposited with the metal electrodes is not as precise as desired. In some embodiments, networking of the channels may be molded onto the polymer materials to include the sample preparation and separation features.

With reference now to FIG. 6, another embodiment of a microfluidic device 160 is shown in perspective view. This microfluidic device 160 is manufactured by bonding a thin polymer film 162 between an upper polymer plate 164 and a lower polymer plate 166, which are made to look “transparent” in FIG. 6 to show the design of thin polymer film 162. Thin polymer film 162 includes a tip 168, as well as one or more alignment features 170 for enabling placement of thin film 162 between the two plates 164, 166 so that tip 168 is aligned with an opening in a microchannel 174. In one embodiment, tip 168 is recessed from an edge 172 of microfluidic device 160. In some embodiments, tip 168 may be partially or completely coated with one or more metals to provide for electrical contact to the ESI tip in embodiments in which the electrospray is combined with other electrokinetically driven operations on microfluidic device 160, such as separation of substances. Advantageously, in some embodiments thin polymer film 162 is cut from a sheet rather than being patterned by lithography. Another advantageous feature of some embodiments is that a single strip or sheet of tips 168 may be aligned and bonded to a whole plate of chips simultaneously. Individual microfluidic devices 160 may then be separated by CNC milling, sawing, die cutting, laser cutting or the like, providing a convenient means for fabricating multiple microfluidic devices 160.

One embodiment of a method for making such microfluidic devices 160 involves first embossing microchannels 174 into one of plates 164, 166. Also alignment features 170 are embossed at or near edge 172 of device to allow for alignment of thin polymer film 162 between plates 164, 166. After embossing microchannel(s) 174, a circular opening 176 is drilled at a location (sometimes centered) at edge 172 of both plates 164, 166. In some embodiments, many devices 160 will be made from upper plate 164 and one lower plate 166, and all openings 176 may be drilled during the same procedure in some embodiments.

A next step, in some embodiments, is to laser-cut thin polymer film 162 (for example metal-coated polyimide or Mylar™) to a desired pattern, including alignment features 170. Thin film 162 may have any suitable thickness, but in some embodiments it will be between about 5 μms and about 15 μms. Before bonding, a strip of the laser-cut metal-coated polymer thin film 162 is placed between plates 164, 166 and is aligned using the etched alignment features 170. Holes 176 in plates 164, 166 are also aligned. In some embodiments, one strip of thin polymer film 162 may be used for an entire row of adjacent devices 160 on a larger precursor plate. Then, polymer plates 164, 166 are thermally bonded together, thereby bonding thin polymer film 162 between them. One goal of this step is to seal over thin polymer film 162 without unduly harming or flattening microchannel 174. Finally, individual microfluidic devices 160 may be separated by any suitable methods, such as by CNC milling, sawing, die cutting or laser cutting. These cuts generally pass through the centers of holes 176.

Many different embodiments of the above-described microfluidic device 160 and methods for making it are contemplated within the scope of the invention. For example, in some embodiments, one device 160 may be made at a time, while in other embodiments multiple devices 160 may be made from larger precursor materials and may then be cut into multiple devices 160. Also, any suitable material may be used for thin film 162, though one embodiment uses a metal-coated polymer. Some embodiments, for example, may use a Mylar™ film having a thickness of about 6 μms and coated with aluminum, or a polyimide film coated with gold, or the like. Additionally, any of a number of different methods may be used to cut thin film 162, plates 164, 166 and the like, such as laser cutting with a UV laser, CO2 laser, YAG laser or the like, Excimer, die-cutting, machining, or any other suitable technique.

Several exemplary embodiments of microfluidic devices and methods for making and using those devices have been described. These descriptions have been provided for exemplary purposes only and should not be interpreted to limit the invention in any way. Many different variations, combinations, additional elements and the like may be used as part of the invention without departing from the scope of the invention as defined by the claims.

1. A microfluidic device for providing one or more substances to a mass spectrometer for analysis of the substances, the microfluidic device comprising:
a microfluidic body having first and second major surfaces and at least one edge surface;
at least one microchannel disposed between the first and second major surfaces, the microchannel having a microfabricated surface;
at least one outlet in fluid communication with the microchannel and disposed along the edge surface; and
at least one tip surface extending from the outlet and disposed in a path of fluid flow from the outlet, the tip surface having at least one fluid guiding feature to help guide fluid from the outlet toward the mass spectrometer.

2. A microfluidic device as in claim 1, wherein the microfabricated surface is disposed on one of the first and second major surfaces and the at least one tip surface comprises an extension of the other of the first and second major surfaces beyond the outlet.

3. A microfluidic device as in claim 2, wherein the at least one microchannel is enclosed between the first surface and the second surface.

4. A microfluidic device as in claim 3, wherein the at least one microchannel comprises at least two intersecting microchannels.

5. A microfluidic device as in claim 1, wherein the at least one tip surface comprises a protruding portion of a layer of film disposed between the first and second major surfaces.

6. A microfluidic device as in claim 1, wherein the at least one fluid guiding feature comprises a linear surface feature extending from a first location on the tip near the outlet to a second location at an edge of the tip.

7. A microfluidic device as in claim 6, wherein the at least one linear surface feature comprises a groove extending at least partially through a thickness of the tip surface.

8. A microfluidic device as in claim 7, wherein the groove extends completely through the thickness of the tip surface.

9. A microfluidic device as in claim 6, wherein the groove comprises a laser-cut groove.

10. A microfluidic device as in claim 6, wherein the at least one tip surface comprises a pointed tip, and the at least one linear feature extends from the outlet to a point of the tip.

11. A microfluidic device as in claim 6, wherein the at least one tip surface comprises an apex with a local radius of curvature of less than 40 micrometers.

12. A microfluidic device as in claim 6, wherein at least part of the at least one linear surface feature comprises a hydrophilic surface.

13. A microfluidic device as in claim 12, wherein the hydrophilic surface extends along an entire length of the at least one linear surface feature.

14. A microfluidic device as in claim 13, wherein the hydrophilic surface comprises at least one of a coated surface, a gel matrix, a polymer, a sol-gel monolith and a chemically modified surface.

15. A microfluidic device as in claim 14, wherein a coating on the coated surface comprises a material selected from the group consisting of cellulose polymers, polyacrylamide, polydimethylacrylamide, acrylamide-based copolymer, polyvinyl alcohol, polyvinylpyrrolidone, plyethylene oxide, Pluronic™ polymers, poly-N-hydroxyethylacrylamide, Tween™, dextran, a sugar, hydroxyethyl methacrylate and indoleacetic acid.

16. A microfluidic device as in claim 14, wherein the chemically modified surface has been modified by at least one of gas plasma treatment, plasma polymerization, corona discharge treatment, UV/ozone treatment, laser treatment, laser ablation and an oxidizing solution.

17. A microfluidic device as in claim 1, wherein the at least one fluid guiding feature comprises a hydrophilic surface along at least part of the tip surface.

18. A microfluidic device as in claim 17, wherein the at least one fluid guiding feature further comprises a hydrophobic surface along part of the tip surface.

19. A microfluidic device as in claim 1, wherein the tip surface directs the one or more substances toward the mass spectrometer at a flow rate of between about 10 and about 1000 nanoliters/minute.

20. A microfluidic device as in claim 1, wherein the outlet and the tip surface are recessed into the microfluidic body relative to an adjacent portion of the edge surface.

21. A microfluidic device as in claim 1, wherein at least part of the microfabricated surface comprises a hydrophilic surface.

22. A microfluidic device as in claim 21, wherein the hydrophilic surface comprises a part of the microfabricated surface adjacent the outlet.

23. A microfluidic device as in claim 21, wherein the hydrophilic surface is disposed along the entire length of the microfabricated surface.

24. A microfluidic device as in claim 21, wherein the hydrophilic surface comprises at least one of a coated surface, a gel matrix, a polymer, a sol-gel monolith and a chemically modified surface.

25. A microfluidic device as in claim 24, wherein a coating on the coated surface comprises a material selected from the group consisting of cellulose polymers, polyacrylamide, polydimethylacrylamide, acrylamide-based copolymer, polyvinyl alcohol, polyvinylpyrrolidone, plyethylene oxide, Pluronic™ polymers, poly-N-hydroxyethylacrylamide, Tween™, dextran, a sugar, hydroxyethyl methacrylate and indoleacetic acid.

26. A microfluidic device as in claim 24, wherein the chemically modified surface has been modified by at least one of gas plasma treatment, plasma polymerization, corona discharge treatment, UV/ozone treatment, laser treatment, laser ablation and an oxidizing solution.

27. A microfluidic device as in claim 1, wherein at least one of the first major surface, the second major surface and the edge surface comprises, at least in part, a hydrophobic surface.

28. A microfluidic device as in claim 27, wherein the at least one hydrophobic surface is disposed adjacent the outlet.

29. A microfluidic device as in claim 1, wherein at least one of the first and second major surfaces comprises a material selected from the group consisting of glass, silicon, ceramic, polymer, copolymer, silicon dioxide, quartz, silica and a combination thereof.

30. A microfluidic device as in claim 29, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

31. A microfluidic device as in claim 1, further comprising a source of pressure coupled with the device to move the substances through the microchannel.

32. A microfluidic device as in claim 1, further comprising a source of electrical potential coupled with the device to move the substances through the microchannel by elctroosmotic flow.

33. A microfluidic device as in claim 1, further comprising a source of electrical potential coupled with the device to move the substances through the microchannel by electrophoresis.

34. A microfluidic device as in claim 33, wherein the electrical potential source comprises an electrical potential microchannel in fluid communication with the microchannel, the electrical potential microchannel containing at least one electrically conducting substance.

35. A microfluidic device as in claim 33, wherein the electrical potential source comprises an electrical potential microchannel which exits the microfluidic device immediately adjacent the microchannel, the electrical potential microchannel containing at least one electrically charged substance.

36. A microfluidic device as in claim 33, wherein the electrical potential source comprises at least one electrode on the microfluidics device.

37. A microfluidic device as in claim 36, wherein the at least one electrode provides potential for effecting at least one of electrophoretic separation of the substances and electrospray ionization.

38. A microfluidic device as in claim 36, wherein the at least one electrode provides potential for effecting at least one of electrokinetic movement of the substances in the microchannel and electrospray ionization.

39. A microfluidic device as in claim 36, wherein the electrode comprises at least one of copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

40. A microfluidic device as in claim 36, wherein the at least one electrode generates the electrical potential without producing a significant quantity of bubbles in the one or more substances.

41. A microfluidic device for providing one or more substances to a mass spectrometer for analysis of the substances, the microfluidic device comprising:
a substrate comprising at least one layer, the substrate including at least one microchannel, wherein the substances are movable within the microchannel;
a cover arranged over the substrate;
at least one outlet in fluid communication with the microchannel for allowing egress of the substances from the microchannel; and
at least one tip surface extending the cover beyond the outlet, the tip surface having at least one fluid guiding feature to help guide fluid from the outlet toward the mass spectrometer.

42. A microfluidic device as in claim 41, wherein the at least one microchannel is enclosed between the substrate and the cover.

43. A microfluidic device as in claim 41, wherein the at least one microchannel comprises at least two intersecting microchannels.

44. A microfluidic device as in claim 41, wherein the at least one fluid guiding feature comprises a linear surface feature extending from a first location on the tip near the outlet to a second location at an edge of the tip.

45. A microfluidic device as in claim 44, wherein the at least one linear surface feature comprises a groove extending at least partially through a thickness of the tip surface.

46. A microfluidic device as in claim 45, wherein the groove extends completely through the thickness of the tip surface.

47. A microfluidic device as in claim 44, wherein the groove comprises a laser-cut groove.

48. A microfluidic device as in claim 44, wherein the at least one tip surface comprises a pointed tip, and the at least one linear feature extends from the outlet to a point of the tip.

49. A microfluidic device as in claim 44, wherein the at least one tip surface comprises an apex with a local radius of curvature of less than 40 micrometers.

50. A microfluidic device as in claim 44, wherein at least part of the at least one linear surface feature comprises a hydrophilic surface.

51. A microfluidic device as in claim 50, wherein the hydrophilic surface extends along an entire length of the at least one linear surface feature.

52. A microfluidic device as in claim 50, wherein the hydrophilic surface comprises at least one of a coated surface, a gel matrix, a polymer, a sol-gel monolith and a chemically modified surface.

53. A microfluidic device as in claim 52, wherein a coating on the coated surface comprises a material selected from the group consisting of cellulose polymers, polyacrylamide, polydimethylacrylamide, acrylamide-based copolymer, polyvinyl alcohol, polyvinylpyrrolidone, plyethylene oxide, Pluronic™ polymers, poly-N-hydroxyethylacrylamide, Tween™, dextran, a sugar, hydroxyethyl methacrylate and indoleacetic acid.

54. A microfluidic device as in claim 52, wherein the chemically modified surface has been modified by at least one of gas plasma treatment, plasma polymerization, corona discharge treatment, UV/ozone treatment, laser treatment, laser ablation and an oxidizing solution.

55. A microfluidic device as in claim 41, wherein the at least one fluid guiding feature comprises a hydrophilic surface along at least part of the tip surface.

56. A microfluidic device as in claim 55, wherein the at least one fluid guiding feature further comprises a hydrophobic surface along part of the tip surface.

57. A microfluidic device as in claim 41, wherein the tip surface directs the one or more substances toward the mass spectrometer at a flow rate of between about 10 and about 1000 nanoliters/minute.

58. A microfluidic device as in claim 41, wherein the outlet and the tip surface are recessed into the microfluidic body relative to an adjacent portion of the edge surface.

59. A microfluidic device as in claim 41, wherein the cover comprises at least one material selected from the group consisting of glass, silicon, ceramic, polymer, copolymer, silicon dioxide, quartz and silica.

60. A microfluidic device as in claim 59, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

61. A method of making a microfluidic device for providing one or more substances to a mass spectrometer for analysis of the substances, the method comprising:
fabricating a substrate comprising:
forming at least one microchannel having a microfabricated surface; and
forming an outlet in fluid communication with the microchannel and disposed along an edge surface of the substrate;
fabricating a cover having at least one tip surface with at least one fluid guiding feature to help guide fluid from the outlet toward the mass spectrometer; and
applying the cover to the substrate.

62. A method as in claim 61, wherein fabricating the substrate comprises forming at least two intersecting microchannels.

63. A method as in claim 61, wherein fabricating the cover comprises:
forming the at least one tip surface in a cover precursor material; and
forming the at least one fluid guiding feature in the tip surface.

64. A method as in claim 63, wherein forming the fluid guiding feature comprises forming at least one linear surface feature in the tip surface.

65. A method as in claim 64, wherein forming the at least one linear surface feature comprises forming a groove extending at least partially through a thickness of the tip surface.

66. A method as in claim 65, wherein the groove extends completely through the thickness of the tip surface.

67. A method as in claim 65 or 66, wherein forming the tip surface comprises forming a pointed tip, and forming the groove comprises extending the groove from the outlet to a point of the pointed tip.

68. A method as in claim 65 or 66, wherein forming the tip surface comprises forming an apex with a local radius of curvature of less than 40 micrometers, and forming the groove comprises extending the groove from the outlet to an edge of the semi-circular tip.

69. A method as in claim 65, wherein forming the groove comprises cutting the groove into the tip surface using a laser.

70. A method as in claim 64, wherein forming the at least one linear surface feature comprises forming at least part of the linear surface feature with a hydrophilic surface.

71. A method as in claim 70, wherein the hydrophilic surface extends along an entire length of the at least one surface feature.

72. A method as in claim 71, wherein the hydrophilic surface comprises at least one of a coated surface, a gel matrix, a polymer, a sol-gel monolith and a chemically modified surface.

73. A method as in claim 72, wherein a coating on the coated surface comprises a material selected from the group consisting of cellulose polymers, polyacrylamide, polydimethylacrylamide, acrylamide-based copolymer, polyvinyl alcohol, polyvinylpyrrolidone, plyethylene oxide, Pluronic™ polymers, poly-N-hydroxyethylacrylamide, Tween™, dextran, a sugar, hydroxyethyl methacrylate and indoleacetic acid.

74. A method as in claim 72, wherein the chemically modified surface has been modified by at least one of gas plasma treatment, plasma polymerization, corona discharge treatment, UV/ozone treatment, laser treatment, laser ablation and an oxidizing solution.

75. A method as in claim 74, wherein laser ablation is used to cut at least one groove in the surface, and wherein laser ablating the groove in the surface causes the cut surface to be more hydrophilic than an adjacent uncut surface.

76. A method as in claim 63, wherein forming the fluid guiding feature comprises forming at least part of the tip surface with a hydrophilic surface.

77. A method as in claim 76, wherein forming the fluid guiding feature further comprises forming part of the tip surface with a hydrophobic surface.

78. A method as in claim 61, wherein fabricating the substrate and applying the cover comprises recessing the outlet and the tip surface relative to an adjacent portion of the edge surface.

79. A method as in claim 61, wherein the tip surface directs the one or more substances toward the mass spectrometer at a flow rate of between about 10 and about 1000 nanoliters/minute.

80. A method as in claim 61, wherein forming the at least one microchannel comprises applying a hydrophilic coating to at least part of the microfabricated surface.

81. A method as in claim 80, wherein applying the coating comprises introducing the coating into the microchannel under sufficient pressure to advance the coating to the outlet.

82. A method as in claim 80, wherein applying the coating comprises applying at least one of a gel matrix, a polymer, a sol-gel monolith and a chemically modified surface.

83. A method as in claim 82, wherein the coating comprises a material selected from the group consisting of cellulose polymers, polyacrylamide, polydimethylacrylamide, acrylamide-based copolymer, polyvinyl alcohol, polyvinylpyrrolidone, plyethylene oxide, Pluronic™ polymers, poly-N-hydroxyethylacrylamide, Tween™, dextran, a sugar, hydroxyethyl methacrylate and indoleacetic acid.

84. A method as in claim 82, wherein the chemically modified surface has been modified by at least one of gas plasma treatment, plasma polymerization, corona discharge treatment, UV/ozone treatment, laser treatment, laser ablation and an oxidizing solution.

85. A method as in claim 84, wherein laser ablation is used to cut at least one groove in the surface, and wherein laser ablating the groove in the surface causes the cut surface to be more hydrophilic than an adjacent uncut surface.

86. A method as in claim 61, wherein fabricating at least one of the substrate and the cover comprises, at least in part, forming a hydrophobic surface.

87. A method as in claim 86, wherein the at least one hydrophobic surface is disposed adjacent the outlet.

88. A method as in claim 61, wherein at least one of the substrate and the cover are fabricated from a material selected from the group consisting of glass, silicon, ceramic, polymer, copolymer, silicon dioxide, quartz, silica and a combination thereof.

89. A method as in claim 88, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

90. A method as in claim 61, further comprising coupling a source of pressure with the device to move the substances through the microchannel.

91. A method as in claim 61, further comprising coupling an electrical potential source with the device to move the substances through the microchannel by electrophoretic or electrokinetic mobility.

92. A method as in claim 91, wherein the electrical potential source comprises an electrical potential microchannel in fluid communication with the microchannel, the electrical potential microchannel containing at least one electrically charged substance.

93. A method as in claim 91, wherein the electrical potential source comprises an electrical potential microchannel which exits the microfluidic device immediately adjacent the microchannel, the electrical potential microchannel containing at least one electrically charged substance.

94. A method as in claim 91, wherein the electrical potential source comprises at least one electrode on the microfluidic device.

95. A method as in claim 94, wherein the at least one electrode provides potential for effecting at least one of electrophoretic separation of the substances and electrospray ionization.

96. A method as in claim 94, wherein the at least one electrode provides potential for effecting at least one of electrokinetic movement of the substances in the microchannel and electrospray ionization.

97. A method as in claim 94, wherein the at least one electrode comprises at least one of copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

98. A method as in claim 94, wherein the at least one electrode provides the electrical potential without producing a significant quantity of bubbles in the substances.

99. A method as in claim 61, further comprising:
making at least two connected microfluidic devices from one or more common pieces of starting material; and
separating the at least two microfluidic devices by cutting the common pieces of starting material.

100. A method as in claim 61, wherein the at least one microchannel is formed by at least one of photolithographically masked wet-etching, photolithographically masked plasma-etching, embossing, molding, injection molding, photoablating, micromachining, laser cutting, milling, die cutting, reel-to-reel methods, photopolymerizing and casting.

101. A method for making a microfluidic device for providing one or more substances to a mass spectrometer for analysis of the substances, the method comprising:
fabricating a microfluidic body comprising:
first and second major surfaces with an edge surface therebetween;
at least one microchannel disposed between the first and second major surfaces, the microchannel having a microfabricated surface;
an outlet in fluid communication with the microchannel and disposed along the edge surface; and
at least one tip surface extending one of the first and second major surfaces beyond the outlet, the tip surface having at least one fluid guiding feature to help guide fluid from the outlet toward the mass spectrometer.

102. A method of making microfluidic devices for providing one or more substances to a mass spectrometer for analysis of the substances, the method comprising:
forming at least one microchannel on a first substrate;
providing a layer of film having at least one tip and at least one alignment feature, the tip having at least one fluid guiding feature to help guide fluid from the outlet toward the mass spectrometer;
aligning the layer of film between the first substrate and a second substrate; and
bonding the layer of film between the first and second substrates.

103. A method as in claim 102, wherein forming the at least one microchannel comprises embossing the microchannel onto the first substrate.

104. A method as in claim 102, further comprising forming a recessed edge in the first and second substrates.

105. A method as in claim 104, wherein forming the recessed edge comprises drilling a semi-circular recession into an edge of the first substrate and the second substrate.

106. A method as in claim 102, wherein providing the layer of film comprises providing a polymer film.

107. A method as in claim 106, wherein the polymer comprises a material selected from the group consisting of cyclic polyolefin, polycarbonate, polystyrene, PMMA, acrylate, polyimide, epoxy, polyethylene, polyether, polyethylene terephtalate, polyvinyl chloride, polydimethylsiloxane, polyurethane, polypropylene, phenol formaldehyde, polyacrylonitrile, Mylar™, Teflon™ and other acrylic-based polymers.

108. A method as in claim 106, wherein the polymer is at least partially coated with at least one conductive material.

109. A method as in claim 108, wherein the conductive material comprises a material selected from the group consisting of copper, nickel, conductive ink, silver, silver/silver chloride, gold, platinum, palladium, iridium, aluminum, titanium, tantalum, niobium, carbon, doped silicon, indium tin oxide, other conductive oxides, polyanaline, sexithiophene, polypyrrole, polythiophene, polyethylene dioxythiophene, carbon black, carbon fibers, conductive fibers, and other conductive polymers and conjugated polymers.

110. A method as in claim 102, wherein providing the layer of film comprises providing a metallic film.

111. A method as in claim 108, wherein the metallic film comprises a metal selected from the group consisting of copper, nickel, conductive ink, silver, silver/silver chloride, gold, platinum, other noble metals, palladium, iridium, aluminum, titanium, tantalum and niobium.

112. A method as in claim 102, wherein providing the layer of film comprises forming at least one linear surface feature in the tip.

113. A method as in claim 112, wherein forming the linear surface feature comprises forming a groove in the tip extending through at least part of a thickness of the tip.

114. A method as in claim 113, wherein forming the groove comprises extending the groove through the full thickness of the tip.

115. A method as in claim 113, wherein the groove is formed using at least one of laser cutting, die-cutting or machining.

116. A method as in claim 113, further comprising forming at least part of the groove from a hydrophilic material.

117. A method as in claim 102, wherein providing the layer of film comprises forming the at least one tip and the at least one alignment feature using at least one of laser cutting, die-cutting or machining.

118. A method as in claim 102, further comprising forming at least one complementary alignment feature on at least one of the first and second substrates to provide alignment of the layer of film with the first and second substrates.

119. A method as in claim 102, wherein aligning comprises aligning the at least one alignment feature on the layer of film with at least one complementary alignment feature on at least one of the first and second substrates.

120. A method as in claim 102, wherein bonding comprises thermally bonding the first substrate to the second substrate with the layer of film disposed in between.

121. A method as in claim 102, further comprising separating the bonded first substrate, second substrate and layer of film to produce multiple microfluidic devices.

122. A method for providing at least one substance from a microfluidic device into a mass spectrometer, the method comprising:
moving the at least one substance through at least one microchannel in the microfluidic device;
causing the at least one substance to pass from the microchannel out of an outlet at an edge of the microfluidic device to contact at least one tip surface of the microfluidic device; and
directing the at least one substance along a linear surface feature of the tip surface, the linear surface feature extending from immediately adjacent the outlet toward the mass spectrometer.

123. A method as in claim 122, wherein the linear surface feature comprises a groove extending at least partially through a thickness of the tip surface.

124. A method as in claim 123, wherein the groove extends completely through the thickness of the tip surface.

125. A method as in claim 123 or 124, wherein the tip surface comprises a point, and the groove extends from the outlet to an end of the point.

126. A method as in claim 123, wherein the groove comprises a laser-cut groove.

127. A method as in claim 122, wherein the at least one substance is directed toward the mass spectrometer at a flow rate of between about 10 and about 1000 nanoliters/minute.

128. A method as in claim 122, wherein providing the at least one substance comprises providing at least one substance in the form of ions.

129. A method as in claim 122, wherein the at least one substance is moved through at least one microchannel by applying an electrical potential to the substance.

130. A method as in claim 129, further including using the electrical potential to separate one or more substances.

131. A method as in claim 129, wherein applying the electrical potential to the substance does not generate a significant amount of bubbles in the substance.

132. A method as in claim 122, wherein the at least one substance is moved through at least one microchannel via pressure.

133. A method as in claim 122, wherein causing the substance to pass from the microchannel out of the outlet comprises directing the substance with at least one hydrophobic surface, and directing the substance with at least one surface of the microfluidic device selected from the group consisting of a hydrophilic surface and a surface that minimizes protein binding.

134. A method as in claim 122, wherein causing the substance to pass from the microchannel out of the outlet comprises directing the substance out of the outlet in a direction approximately parrallel to a longitudial axis of the at least one microchannel.

135. A method as in claim 122, wherein causing the substance to pass from the microchannel out of the outlet comprises directing the substance out of the outlet in a direction non-parallel to a longitudinal axis of the at least one microchannel.

136. A method as in claim 122, wherein causing the substance to pass from the microchannel out of the outlet comprises directing the substance out of the outlet in the form of a spray.

137. A method as in claim 122, wherein the spray has a desired spray geometry.
